(19) United States
(12) Patent Application Publication
(10) Pub. No.: US 2011/0191069 A1
(43) Pub. Date: Aug. 4, 2011

(54) SYSTEM AND METHOD FOR DESIGNING A BUILDING

(75) Inventors: Tyge Madsen, Ascot (AU); Russell Gregory Bailey, South Perth (AU); Nick Thomas Southwell, South Perth (AU)

(73) Assignee: TRIPOD COMPONENTS PTY LTD, Ascot (AU)

(21) Appl. No.: 13/002,203

(22) PCT Filed: Jun. 30, 2009
(86) PCT No.: PCT/AU09/00832

§ 371 Date: Apr. 25, 2011

(30) Foreign Application Priority Data
Jun. 30, 2008 (AU) 2008903347

(51) Int. Cl. G06F 17/50

(52) U.S. Cl. 703/1

(57) ABSTRACT

An automated method and system generates a specification or construction of a building based upon a floor plan, and using modular elements selected from a predetermined set of modular element types. Computer-readable input data representative of a user-generated floor plan is received, which is made up of modular elements arranged in accordance with a regular grid. The input data is processed to produce computer-readable specification data which includes a specification for construction of a building from the modular elements, in accordance with the floor plan. At least one output file is generated, which includes information for use in construction of a building in accordance with the building specification data. The invention enables the design of modular building structures, which can be deployed relatively rapidly and cheaply, by users having no particular skills in building design and/or structural engineering. The system and method are therefore particularly useful for meeting building deployment requirements in remote areas, and in circumstances such as military operations or response to natural disasters.

### FIELD OF THE INVENTION

The invention relates generally to computer-aided design of buildings, and more particularly to a system and method facilitating the computer-aided design of a modular building construction.

### BACKGROUND OF THE INVENTION

Traditional building methods, such as brick and mortar construction, have characteristics which make them generally unsuitable for rapid and/or low-cost deployment, such as may be required during military operations or in response to natural disasters. In particular, such conventional building construction requires the use of a variety of skilled labour, such as bricklayers, concreters, plasterers, plumbers, carpenters and the like. Where the building is to be constructed in a remote location, problems associated with sourcing the required labour are exacerbated. The process is generally labour- and materials-intensive, time-consuming, and relatively expensive.

In response to the need for structures that are better-suited for relatively rapid and low-cost deployment, International Application Publication No. WO 2005/124049 discloses a modular construction for a building, having wall modules, floor modules, ceiling modules and roof modules. This construction represents a readily transportable modular arrangement which does not require extensive site preparation prior to construction. As such, a modular building can be quickly assembled on-site using relatively unskilled labour. The disclosure of International Application Publication No. WO 2005/124049, and corresponding U.S. application Ser. No. 11/629,702, are herein incorporated in their entirety by reference.

The size and shape of a modular building can be determined according to need. While this flexibility is an advantage of the modular construction approach, it can slow down the construction process. Each structure to be built must first be designed. When the design is complete, an inventory of the number and type of components may be prepared. The required components must then be collected, packed and transported to the construction site.

Traditional drafting and computer-aided design (CAD) techniques assist architects and designers in completing technical drawings. However, these systems rely on the individual operator having expertise in the use of the relevant design techniques, as well as in the underlying technical field. The resulting drawings also require specialist skills for interpretation.

It would therefore be desirable to provide a means by which a relatively unskilled operator can design a modular building. Such means would be of most use when able to provide the user with an impression of the final appearance of the designed building, and also able to verify that the final building design meets required criteria, such as engineering strength criteria, without requiring the user to possess the relevant expertise.

It is accordingly an object of the present invention to provide a method and system which assists or enables a relatively unskilled operator to design a modular building. Embodiments of the invention are particularly directed, although not necessarily limited, to the design of modular building constructions utilising the principles and components disclosed in International Application Publication No. WO 2005/124049.

### SUMMARY OF THE INVENTION

In one aspect, the present invention provides an automated method of generating a specification for construction of a building from modular elements selected from a predetermined set of modular element types, the method including the steps of:

receiving computer-readable input data representative of a user-generated floor plan which comprises a plurality of said modular elements arranged in accordance with a regular grid;

processing the input data to produce computer-readable building specification data which includes a specification for construction of a building from said modular elements, in accordance with the floor plan; and

generating at least one output file including information for use in construction of a building in accordance with the building specification data.

Embodiments of the invention are able to take advantage of the particular constraints of the modular building construction, such as the limited range of available modular element types, and restrictions upon the way the modular elements may be laid out and interconnected, in order to provide an extremely high level of building design automation, thereby enabling a relatively unskilled operator to design a complete building that meets relevant design criteria.

In a preferred embodiment, the step of processing the input data to produce computer-readable building specification data includes verifying that the input data represents a floor plan of an enclosed building structure and/or identifying enclosed areas of the floor plan. Advantageously, this step assists in preventing a user from designing an impractical, inappropriate and/or structurally unsound building.

A preferred method of identifying enclosed areas includes one or more steps of:

scanning the regular grid to identify a location of an initial modular wall element, and

commencing at said initial modular wall element, traversing a perimeter of adjacent modular wall elements in order to identify an enclosed area.

It will be appreciated that a particular building design may include internal wall sections and/or partitions that do not enclose distinct separate areas or rooms, and accordingly an algorithm for traversing a perimeter advantageously includes following one or more possible paths in the event that a junction of multiple modular wall elements is encountered.

The step of processing the input data to produce computer-readable building specification data preferably further includes generating a specification for construction of a roof of the building based upon the floor plan represented by the input data. It is a particular feature of embodiments of the invention that the design and specification of the complete roof structure may be wholly automated, thereby freeing the operator from any involvement in this relatively complex task. In the preferred embodiment, nothing more than the floor plan is required to enable a complete roof construction specification to be generated.

In the preferred embodiment, generation of the roof construction specification includes determining heights and locations of roof lines, including roof ridges, roof hips and/or roof valleys. A particularly preferred algorithm includes one or more steps of:

scanning the regular grid to identify a location of an initial roof element, and

commencing at said initial roof element, traversing a sequence of adjacent roof elements located at the same height as the initial roof element. In this manner, the algorithm effectively identifies a set of roof “contours” of constant height.

More preferably, the algorithm facilitates determination of roof lines including:

a plurality of roof hips defined by diagonal lines of increasing height extending from an external corner of the building;

zero or more roof ridges defined by unenclosed paths of constant height; and

zero or more roof valleys defined by diagonal lines of increasing height extending from an internal corner of the building.

In preferred embodiments, generating a specification for construction of a roof further includes generating a specification for construction of a roof support structure.

In a preferred method, generating the roof support structure specification includes determining placement of a plurality of first supporting members (for example elongate trusses, such as weave trusses) located along lateral and transverse lines running parallel to lines of the regular grid, and arranged in a horizontal configuration. The method preferably further includes determining placement of a plurality of second supporting members (for example further elongate trusses, such as corrugated trusses) located along lines of increasing height between a perimeter of the roof and a corresponding nearest roof line. In the case of a structure including one or more roof valleys, the method may further include determining placement of a plurality of the second supporting members located along lines of increasing height between a roof valley and a corresponding nearest roof ridge or roof hip.

Generating the roof support structure specification may also include determining placement of a plurality of third supporting members (eg suitable struts) located within the roof, and extending from node points positioned on first supporting members located along lateral and transverse lines running parallel to lines of the regular grid.

The step of processing the input data preferably further includes determining the location, type and characteristics of all joins required for construction of the building. Automating this aspect of the building design ensures that the operator is not required to possess the skills and knowledge that would be necessary in order to identify and specify all of the joins required for construction of the building.

The output files generated by the automated method may include one or more of:

a parts list including all components and modular elements required for construction of the building;

a bill of costs, including prices of all components and modular elements required for construction of the building; and

instructions for construction of the building.

In preferred embodiments of the invention, the method includes a further step of verifying that the building construction meets relevant design criteria, such as structural strength criteria.

In another aspect, the invention provides a computer-implemented system for generating a specification for construction of a building from modular elements selected from a predetermined set of modular element types, the system including:

one or more processors;

at least one input interface operatively associated with the processor(s);

at least one output interface operatively associated with the processor(s); and

at least one storage medium containing program instructions for execution by the processor(s), said program instructions causing the processor(s) to execute the steps of:
receiving, via said at least one input interface, computer-readable input data representative of a user-generated floor plan which comprises a plurality of said modular elements arranged in accordance with a regular grid;
processing the input data to produce computer-readable building specification data which includes a specification for construction of a building from said modular elements in accordance with the floor plan; and
generating at said at least one output interface, at least one output file including information for use in construction of a building in accordance with the building specification data.

Preferably, the input and output interfaces include at least one network interface connecting the one or more processors to a data network, wherein input data and output files are transmitted between the system and an end-user via the data network. In a particularly preferred embodiment, the data network is the Internet, and the system provides a web-based building design service. This implementation provides the particular advantage of enabling a user to access the building design service from any location at which Internet access is available, for example using a conventional web browser.

In a further aspect, the present invention provides a computer-implemented system or apparatus for generating a specification for construction of a building from modular elements selected from a predetermined set of modular element types, the system or apparatus including:

means for receiving computer-readable input data representative of a user-generated floor plan which comprises a plurality of said modular elements arranged in accordance with a regular grid;

means for processing the input data to produce computer-readable building specification data which includes a specification for construction of a building from said modular elements in accordance with the floor plan; and

means for generating at least one output file including information for use in construction of a building in accordance with the building specification data.

In yet another aspect, the invention provides a computer-readable medium having computer-executable instructions embodied thereon, which when executed cause a computer to execute a method according to an embodiment of the invention. In particular, the computer-readable medium may be an optical disc (such as a CD or DVD disc), a magnetic disc (such as a floppy disc or hard disc) or a solid-state device (such as a USB flash memory device) or the like, upon which installable and/or executable instruction code is stored in the form of a computer program implementing the building design method.

Further preferred features and advantages of the invention will be apparent to those skilled in the art from the following description of preferred embodiments of the invention, which should not be considered to be limiting of the scope of the invention as defined in the preceding statements, or in the claims appended hereto.

### BRIEF DESCRIPTION OF THE DRAWINGS

Preferred embodiments of the invention are described with reference to the accompanying drawings, in which like reference numerals refer to like features, and wherein:

FIG. 1(a) is a partially cut-away view of a building which can be designed using a process in accordance with the present invention;

FIG. 1(b) shows an exemplary floor plan of a building;

FIGS. 2(a) and 2b) are block diagrams representing the configuration and architecture of a system embodying the present invention;

FIGS. 3(a) and 3(b) are flowcharts illustrating a method of generating a specification for construction of a building according to an embodiment of the invention;

FIG. 4 is a flowchart detailing an algorithm for determining whether an area is enclosed in accordance with an embodiment of the invention;

FIG. 5 is a flowchart detailing an algorithm for determining a next point, being a step within the algorithm of FIG. 4;

FIG. 6 is a flowchart detailing an algorithm for finding adjoining floor plan modules, being a step within the algorithm of FIG. 4;

FIGS. 7(a) to 7(e) are diagrams illustrating the operation of the algorithm represented by the flowcharts in FIGS. 4 to 6 upon the floor plan of FIG. 1(b);

FIG. 8 is a flowchart detailing an algorithm for placing roof elements and determining roof lines of a building in accordance with an embodiment of the invention;

FIG. 9 is a flowchart detailing an algorithm for moving to a next adjoining roof square, being a step within the algorithm of FIG. 8;

FIG. 10 is a flowchart detailing an algorithm for scanning to a next roof square, being a step within the algorithm of FIG. 8;

FIG. 11 is a diagram illustrating the operation of the algorithm illustrated by the flowcharts in FIGS. 8 to 10 upon the floor plan of FIG. 1(b);

FIG. 12 is a flowchart detailing an algorithm for determining the position of a first type of roofing support truss within a building in accordance with and embodiment of the invention;

FIG. 13 is a flowchart detailing an algorithm for determining the position of a second type of roofing support truss within a building in accordance with an embodiment of the invention;

FIG. 14 is a flowchart detailing an algorithm for determining the position of roofing supporting struts within a building in accordance with an embodiment of the invention;

FIG. 15 is a flowchart detailing an algorithm for determining join types for connections within a building according to an embodiment of the present invention;

FIG. 16 is a flowchart detailing an algorithm for finding a join scenario, being a step within the algorithm of FIG. 15; and

FIG. 17 illustrates a three-dimensional graphical model of a building in accordance with the floor plan of FIG. 1(b), designed in accordance with an embodiment of the present invention.

### DETAILED DESCRIPTION OF PREFERRED EMBODIMENT

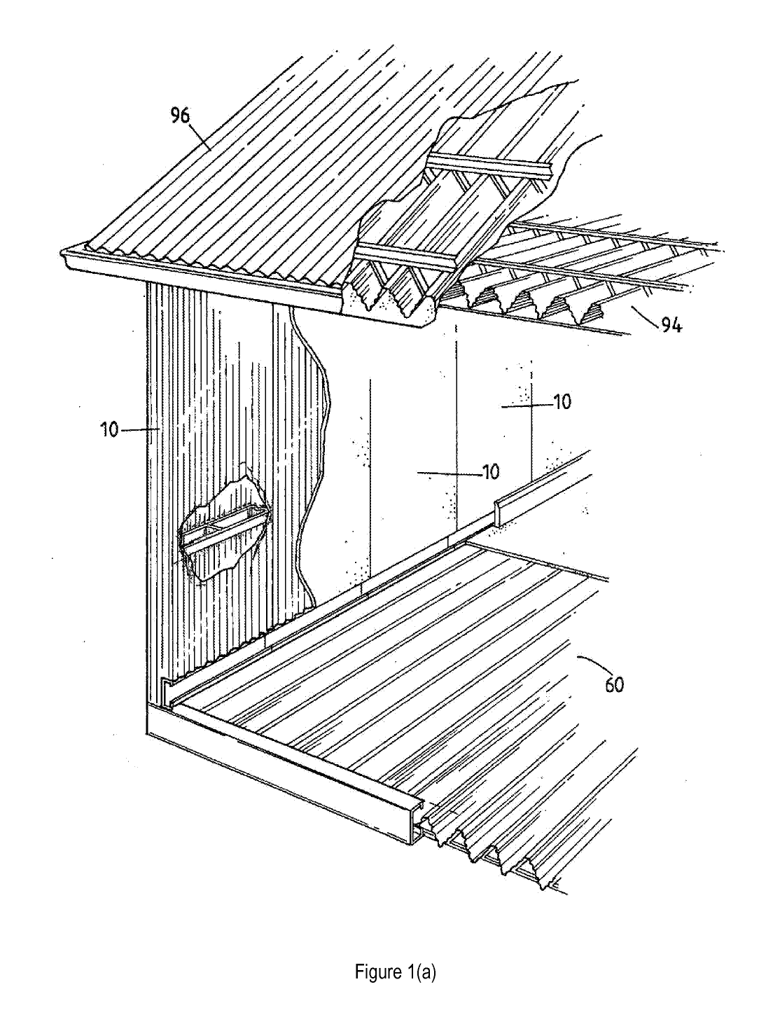

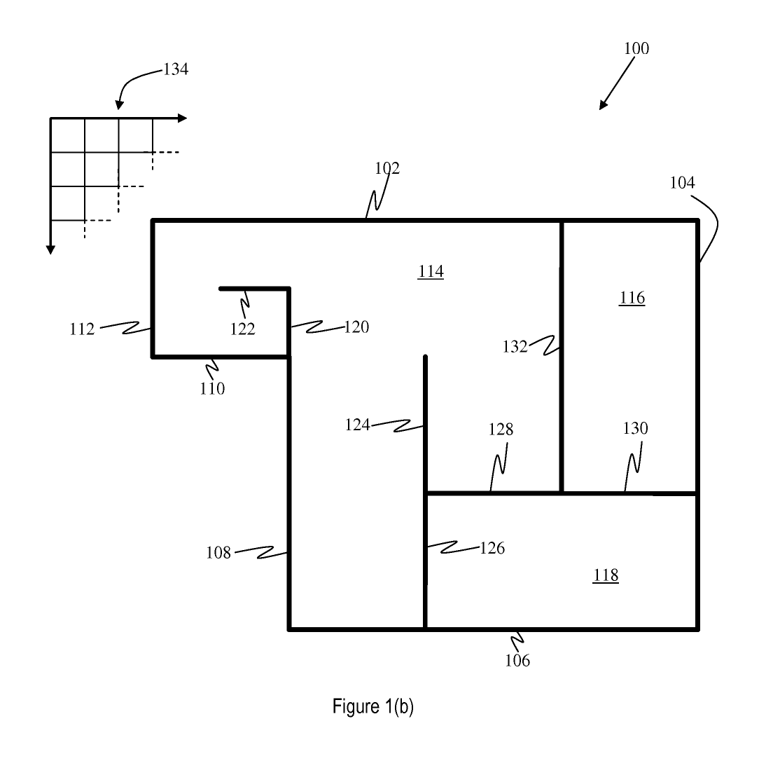

FIG. 1(a) shows a partially cut-away view of a building constructed from modular elements in accordance with the system described in International Patent Application Publication No. WO 2005/124049. The modular elements include wall panels (10) a flooring assembly (60), a ceiling assembly (94) and a roofing assembly (96). The present invention is applicable to assisting a user to design a building to be constructed using these and related modular elements. In particular, embodiments of the present invention provide a computer-aided design system which utilises modular construction elements in the design and specification of a modular building structure.

FIG. 1(b) illustrates an exemplary floor plan 100 of a modular building structure. For convenience, all of the modular wall elements in the floor plan 100 are represented as solid wall panels. However, it will be appreciated that a practical building will include other interior and exterior modular elements, such as doors and windows, and that all such modular elements may be considered generically as “wall elements”, in the sense that they serve to enclose interior portions of the building.

The building floor plan 100 includes exterior walls 102, 104, 106, 108, 110, 112. The interior of the floor plan 100 includes three separate enclosed areas 114, 116, 118. The internal area 114 has an internal configuration determined by the sections of modular wall panelling 120, 122, 124. The three areas 114, 116, 118 are partitioned from one another by interior walls 126, 128, 130, 132, all of which are also made up of modular wall panels. All of the modular elements making up the floor plan 100 are laid out on a notional grid 134 (which extends across the entire area of the floor plan 100, although for clarity only an exemplary portion in the top-left corner is shown in the figure).

In accordance with preferred embodiments of the invention, a user is enabled to design a building having a floor plan such as the plan 100 illustrated in FIG. 1(b) with the assistance of a computer-implemented system.

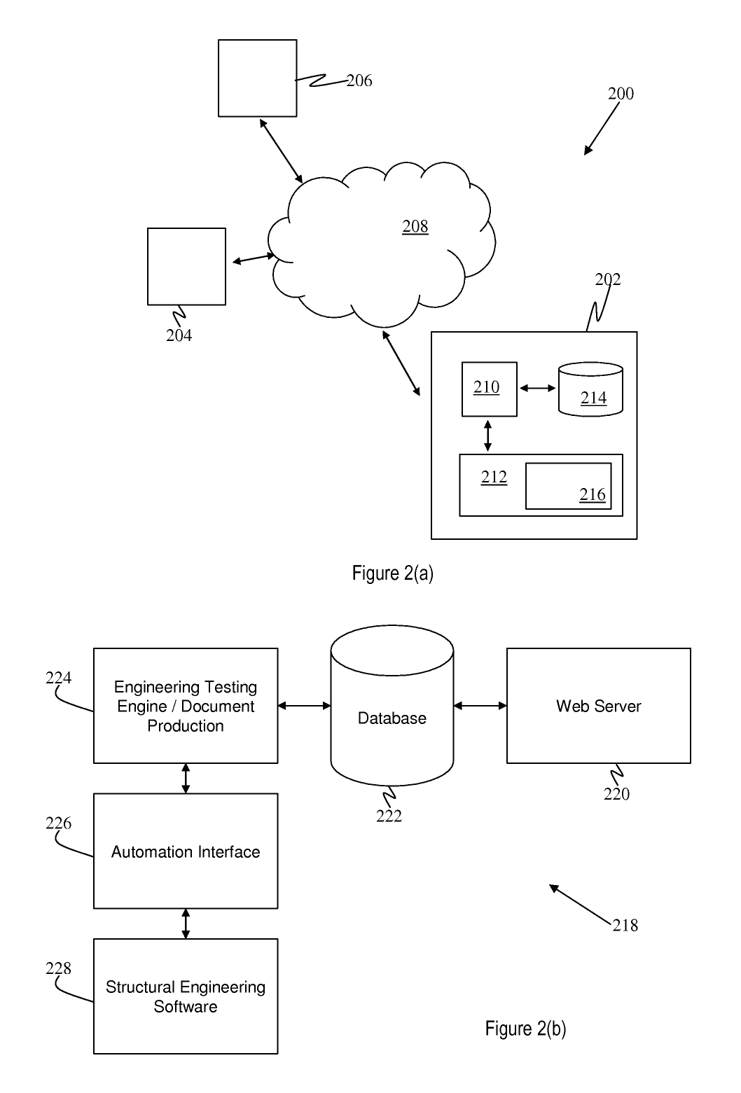

FIG. 2(a) is a schematic diagram representing a networked system configuration 200 embodying the present invention. In particular, the networked system 200 includes a server computer system 202 which may be accessed from one or more user computer systems, eg 204, 206, via a computer network such as the Internet 208. In a preferred embodiment, known communication protocols (eg TCP/IP) and software applications (eg web browser software and associated plug-in components) are utilised to access the server 202 via the network 208, in a conventional manner.

In the system 200 the server 202 consists of a single computer, the configuration and operation of which is described in greater detail below. It will be appreciated, however, that this exemplary embodiment is merely the simplest implementation, and in alternative embodiments the server 202 may include multiple computers and/or processors, which may be either closely coupled, or interconnected via additional network links (not shown).

The exemplary server 202 includes at least one processor 210, which is associated with Random Access Memory 212, used for containing program instructions and transient data related to the operation of the services provided by the server 202. The processor 210 is also operatively associated with a further storage device 214, such as one or more hard disk drives, used for long-term storage of program components, as well as for storage of data relating to the general operation of the server 202, and implementation of an embodiment of the invention, as described in greater detail below.

At any given time, the memory 212 contains a body of program instructions 216 which, when executed by the processor 210, implement various functions of the server 202. These include general operating system functions, as well as specific functionality associated with an embodiment of the present invention, as discussed in general terms below with reference to FIG. 2(b).

More particularly, FIG. 2(b) is a block diagram 218 illustrating a software architecture of an embodiment of the invention. The software provides a web server 220, enabling access to the server 202 from client computers 204, 206 via the Internet 208, utilising conventional web browser software. The web server is able to access a database 222, which may be, for example a MySQL™ database which is physically stored on the storage medium 214.

The software also includes a module 224 comprising the functionality of an engineering testing engine, and document production facilities. The module 224 manages the building design and verification process, and the generation of output data files containing information for use in the construction of a building in accordance with user requirements.

In the preferred embodiment, the module 224 utilises an automation interface 226 in order to access the functionality of structural engineering software module 228. In particular, the structural engineering software 228 may be Multiframe™ integrated structural engineering software from FormSys™. The Multiframe™ software provides an automation interface within the Microsoft™ Windows™ environment which is accessible via Visual Basic. The structural engineering software 228 enables completed building designs to be structurally tested and verified, for example in respect of engineering strength and stability requirements.

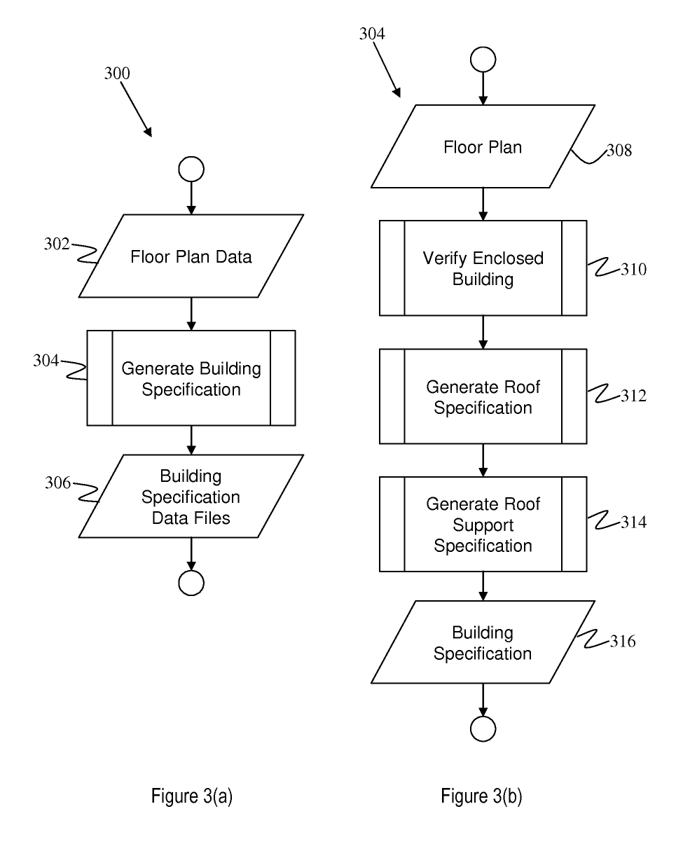

In accordance with the preferred embodiments, a component of the design software is configured to execute on the user/client computers 204, 206. Specifically, a Java™ applet is downloaded to the client computer 204, 206 from the web server 220, and executes within the web browser environment. The Java™ applet provides a design interface for use by the user for entry of a building design, in the form of a floor plan, and to initiate the various design steps described in greater detail below with reference to FIGS. 3 to 17. It will be appreciated that within this particular software architecture, a number of the algorithms described in detail below may be implemented either in the applet executing on the client's computer 204, 206, or in software components executing at the server 202, or in some combination of the two locations. A range of embodiments of the invention within such a distributed computer environment all fall within the scope of the present invention.

In the preferred embodiment of the invention, the Java™ applet provides a graphical user interface via which the user is enabled to enter a design in the form of a floor plan, such as that illustrated in FIG. 1(b), and to view intermediate and final results of the overall design process. In particular, the graphical user interface provides a user with a grid 134 which consists of a regular array of square units, each of which has sides corresponding with the size of the wall modules 10 used in the modular building structure. For example, in a particular embodiment, each grid unit has sides corresponding with 600 mm wall modules.

The graphical user interface provides the user with the ability to draw a two-dimensional floor plan of a building, eg 100, on the grid 134. The user is able to select elements such as wall panels, windows and doors (all of which may be considered to be types of wall modular element) in order to lay out a desired floor plan. A restriction on the user's design is thus that all elements must extend along a side of grid square, and all elements must therefore be parallel or perpendicular to each other. Similarly, the lengths of walls and the like must be in exact multiples of the unit grid size, eg 600 mm.

Once the user has entered a building floor plan via the graphical user interface, there is stored within memory of the client computer eg 204 and/or the server computer 202 a computer-readable input data set which represents the user-generated floor plan. Further processing steps are conducted based upon this input data set. A general process for generating a specification for construction of a corresponding building is illustrated by the flowchart 300 in FIG. 3(a). In particular, the input floor plan data 302 is processed at step 304 to generate computer-readable building specification data which includes a specification for construction of a building from modular elements in accordance with the user-defined floor plan. The generated specification may be used for producing one or more output building specification data files 306. The output data files that may be produced can include, without limitation, computer-readable data files for generating a graphical representation of the completed building design, and computer and/or human readable output files specifying features, characteristics and/or properties of the final building structure, such as an inventory of required components, directions for construction of the building, building structural characteristics, building costs, and so forth.

Further details of the preferred building specification generation process 304 are represented in the flowchart of FIG. 3(b). The floor plan data 308 is analysed at step 310 to verify that it properly represents an enclosed building structure. At step 312 a suitable roof specification is automatically generated. At step 314 a roof support specification is generated. The result of the process 304 is a final building specification 316. Further details of the algorithms employed in the aforementioned process steps will now be described.

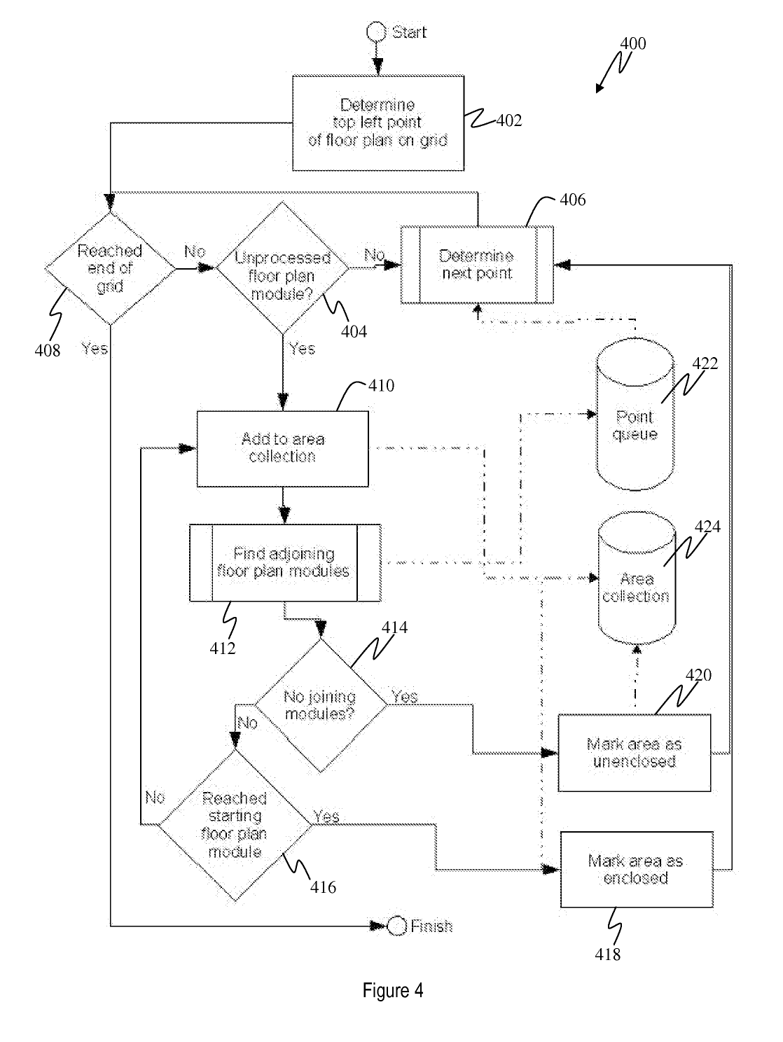

FIG. 4 shows a flowchart 400 detailing an algorithm for determining whether a building floor plan represents a properly enclosed area, in accordance with the preferred embodiment. In general terms, the algorithm involves scanning the complete grid upon which the floor plan has been laid out, to identify the location of modular wall elements placed by the user. In a particularly preferred embodiment, the scanning process commences at the top-left corner of the grid, and proceeds from left to right and top to bottom in order to find unprocessed floor plan modules. Upon identifying an unprocessed module, the algorithm effectively “follows” the wall around a corresponding enclosed area, to confirm that this process results in returning to the originally identified module. Further enclosed areas are then identified by continuing the scan of the grid in search of any remaining unprocessed modules. The process concludes once the end of the grid (ie the bottom right-hand corner) has been reached.

More particularly, the algorithm 400 commences at step 402 by determining the top-left point of the floor plan on the grid. The general scanning process checks at step 404 to determine whether an unprocessed floor plan module has been identified, and if not then the next point in the scan is determined at step 406. This cycle continues until the end of the grid is reached, in accordance with decision step 408.

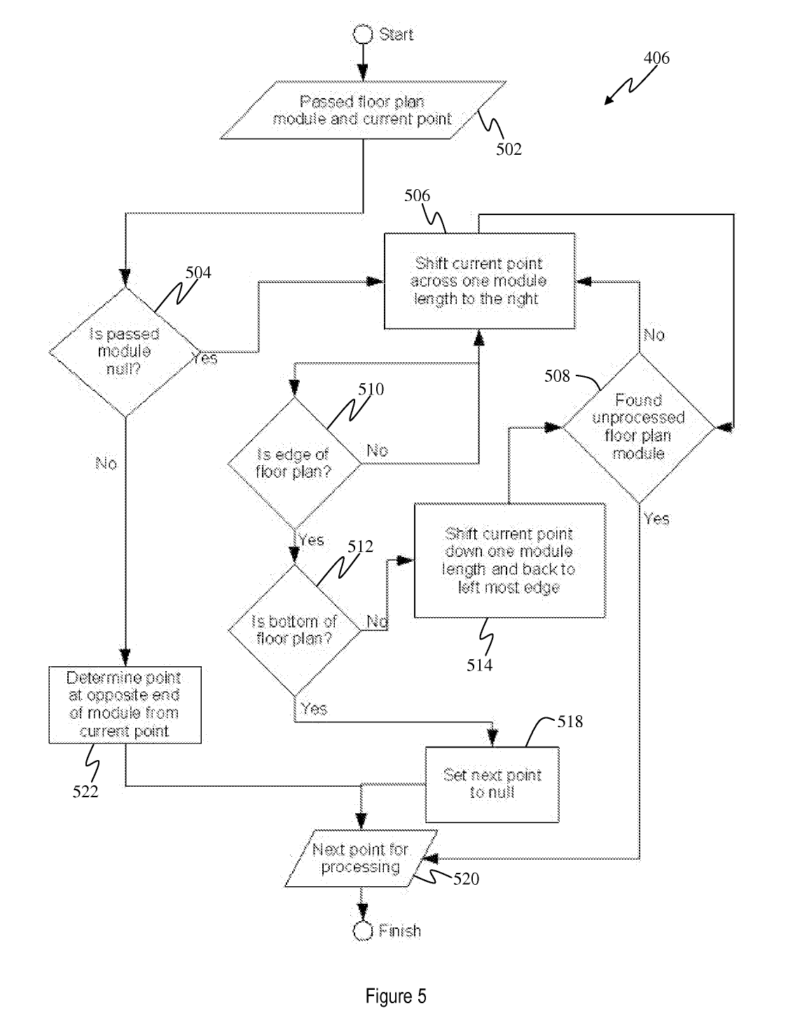

The algorithm 406 for determining the next point is illustrated in greater detail by the flowchart in FIG. 5. The input 502 to this algorithm is the current grid point and corresponding floor plan module. If there is no module at the grid point (ie all adjacent grid lines are vacant) then the input module is null. In this case, control passes at step 504 to step 506, which scans to the next point to the right along the grid. This scanning step is repeated via decision 508, until either an unprocessed floor plan module is found or the end of the grid is reached. In particular, step 510 is a check to see whether the right-hand edge of the floor plan has been reached. If not, then the scan for an unprocessed floor plan module continues along the grid to the right. If the edge has been reached, then a check is made, at step 512, to determine whether the bottom of the floor plan grid has been reached. If not, the current point is incremented down by one grid unit, and back to the left-most edge of the grid. In the event that the end of the grid is reached without identifying a further unprocessed floor plan module, control passes to step 518, which sets the next point to a null value. Alternatively, if an unprocessed floor plan module is found at step 508, then the point corresponding with this module becomes the next point.

Returning to step 504, if the algorithm 406 is passed a valid floor plan module at the current point, then the next point is determined, at step 522, as the point located at the opposite end of the module from the input current point. Accordingly, step 522 implements a process of following wall module elements of the floor plan, irrespective of whether the further modules making up the wall have previously been processed.

The output 520 of the algorithm 406 is the next point for processing.

Returning to the algorithm 400 in FIG. 4, once an unprocessed floor plan module has been identified at step 404, control passes to step 410, the function of which is to verify and collect a corresponding enclosed area. In order to do so, at step 412 an algorithm is employed to identify all of the floor plan modules adjoining the current point. A check is performed at step 414, whereby if there are adjoining modules control passes to step 416, which checks to determine whether the algorithm has returned to the grid point corresponding with the original unprocessed floor plan module passed to step 410. If so, then an enclosed area has been confirmed, and control is passed to step 418 which duly marks the area as enclosed. If the starting grid point has not been reached, control returns to step 410 to continue the area collection process. If there were no adjoining modules identified at step 414, then the area collection process has reached a “dead end”, and is unable to find a complete path back to the starting grid point. This is indicative of an unenclosed area, and control passes to step 420 in which the area is duly marked as unenclosed.

Throughout the above-described process, the algorithm maintains a queue 422 of previously processed points, as well as area collection information 424 used to identify a mark enclosed and unenclosed areas traversed by the algorithm.

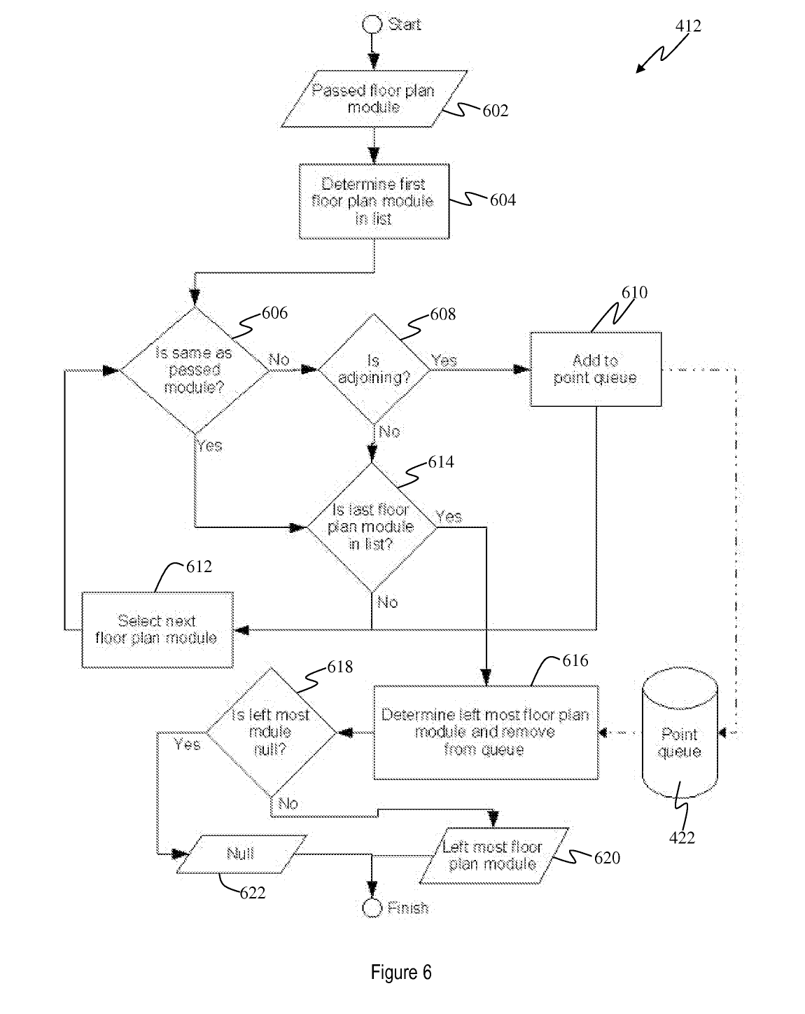

The process for finding adjoining floor plan modules 412 is illustrated in greater detail by the flow chart shown in FIG. 6. The input 602 to this algorithm is a floor plan module on the perimeter of the area currently under investigation.

At step 604 a list of floor plan modules is generated by searching surrounding unit square edges on the grid.

The first floor plan module on the list is then determined. If, at step 606, the determined floor plan module is not the same as the original input floor plan module, then it is checked, at step 608, to determine whether or not it is an adjoining floor plan module. It will be understood that multiple adjoining floor plan modules on the grid represent “junctions” in the floor plan. At a junction, there exist multiple possible paths, any or all of which may lie on the perimeter of an enclosed area. The algorithm 412 must therefore ensure that all of these possible paths are available to be searched. As such, any adjoining module is added to the point queue 422 at step 610. The next floor plan module in the list is then selected, at step 612. Control then returns to decision step 606, in which the next floor plan module is again compared with the original input 602 floor plan module.

When the current floor plan module checked at step 606 is the same as the input floor plan module, a check is performed at step 614 to determine whether it is the last floor plan module in the list. If not, then there remain further potentially adjoining modules to be checked, and control returns to step 612. However, once the input module is the last remaining module, then all potentially adjoining modules have been checked, and control passes to step 616. At this point in the algorithm 412, the point queue 422 includes all of the possible next points that may be visited along an adjoining modular wall element. At step 616 the “left-most” module is selected, and the corresponding point removed from the queue 422. The left-most module will be a modular wall element extending to the left along the grid, if available, or if not then the next preference would be an upwardly-directed element, then a downwardly-directed element and finally a rightwardly-directed element. This particular choice of algorithm results generally in an anticlockwise traversal along enclosed areas.

At decision step 618, a check is performed to determine whether a relevant module was identified at step 616. If so, then the identified module is output 620. If not, then the “left-most” module will be null, and a null output 622 is produced. This latter result corresponds with there being no joining modules at step 414, such that the area will be marked as unenclosed at step 420.

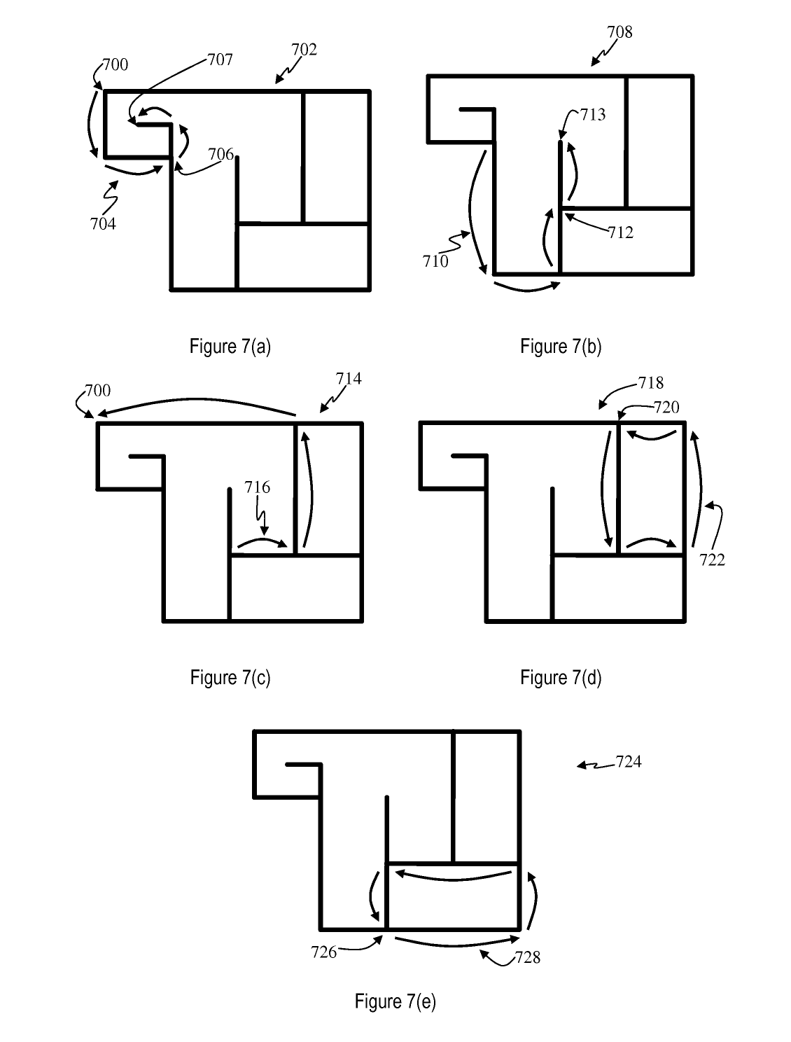

FIGS. 7(a) to 7(e) illustrate the operation of the algorithm 400 to identify the three enclosed areas 114, 116, 118 of the floor plan 100. The illustration 702 in FIG. 7(a) depicts an initial stage of the algorithm, in which the upper-left point 700 of the floor plan 100 is identified. The algorithm proceeds according to the “left-most” rule from this point as indicated by the arrows 704, until the junction 706 is reached. Again the algorithm proceeds in the left-most available direction, until the dead end 707 is encountered. However, the further available adjoining module path at the junction 706 remains on the point queue 422, and thus it is removed from the queue and the algorithm continues as illustrated in the diagram 708 of FIG. 7(b).

In particular, the algorithm proceeds downwardly along the wall module elements as indicated by the arrow 710, until the junction 712 is reached, at which point the left-most path algorithm results in the partition 124 being followed, until the end point 713 is reached. Again, there remains a further alternative path from the junction 712, and so the algorithm returns to this point and proceeds as illustrated in the diagram 714 of FIG. 7(c). In particular, the algorithm now proceeds, in accordance with the left-most decision rule, around the path indicated by the arrows 716, back to the starting point 700, whereby the area 114 is identified as an enclosed area.

As illustrated by the diagram 718 in FIG. 7(d), the next point determination algorithm proceeds to identify the unprocessed modular wall element which remains adjacent (ie to the right) of the junction point 720, and the enclosed area algorithm 400 proceeds around the perimeter of this area, as indicated by the arrows 722, thereby identifying the enclosed area 116.

Finally, as illustrated by the diagram 724 in FIG. 7(e) the next point determination algorithm 406 identifies an unprocessed modular wall element adjacent (ie to the right of) the junction point 726, from which the enclosed area algorithm 400 proceeds in an anticlockwise direction, as indicated by the arrows 728. This results in identification of the final enclosed area 118.

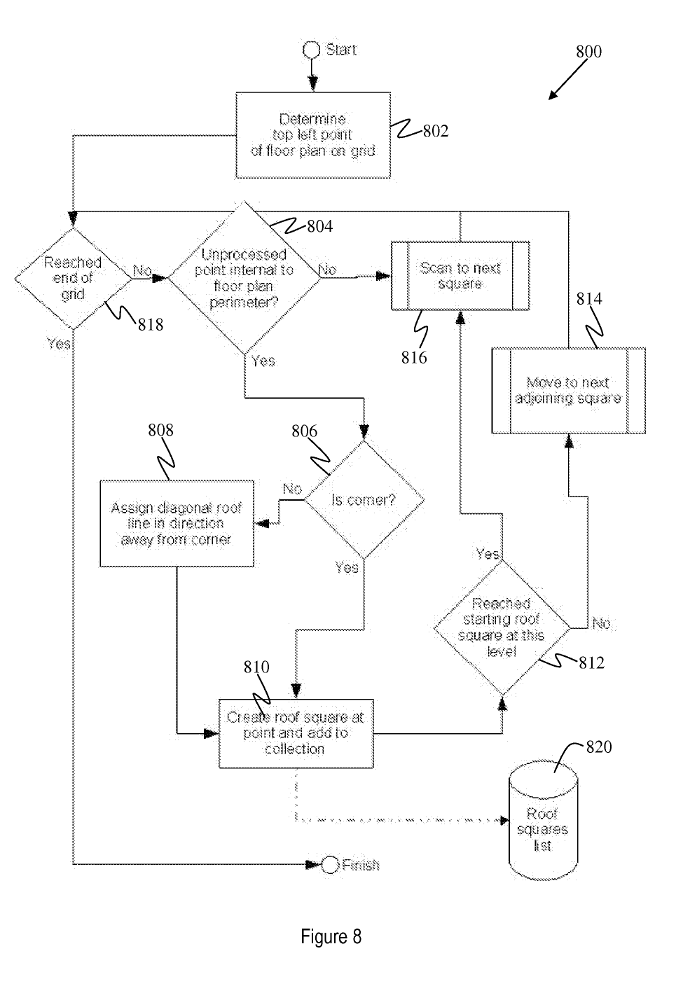

Having verified that the building floor plan 100 comprises a valid enclosed area, the automated design process proceeds to the step 312 of generating a suitable roof specification. The algorithm employed in the preferred embodiment is illustrated in the flowcharts shown in FIGS. 8 to 10. In general, this algorithm is based upon the observation that the roof will generally consist of a plurality of sloping roof elements, and that there will exist on these various elements a number of lines (ie linear “contour” segments) of equal height, ultimately defining one or more roof lines and/or apexes at the highest points of the structure. By starting at the periphery of the building, as defined by the exterior walls 102, 104, 106, 108, 110, 112 of the floor plan 100, the overall external roof structure, and roof lines, can be determined.

The overall algorithm 800 for determining roof lines is illustrated in FIG. 8. In the preferred embodiment, the algorithm 800 for determining roof lines operates using a grid having unit squares with sides half the length of that of the main grid upon which the building is designed. As such, in the presently preferred embodiment having a basic grid unit of 600 mm, the roof line determination algorithm 800 operates on a 300 mm grid. By this expedient, it is guaranteed that each of the walls of a building covers an even number of these grid squares. Additionally, the algorithm 800 commences one (smaller) grid square outside the outer wall of the building, thus defining eaves of 300 mm for the building. The algorithm then follows a series of paths around the exterior of the building roof, noting each 90 degree change-of-direction. Each point on each path thus corresponds to a constant roof height. When the starting point is reached on a particular path, ie when the roof at the corresponding height has been completely traversed, the algorithm moves internally (and upwards) by one small (ie 300 mm) grid step, and again follows this path around the building periphery.

More particularly, as illustrated in the flowchart 800, the algorithm starts at step 802 by determining the top-left point of the floor plan on the grid, ie the point one (small) grid unit upwards and leftwards of the point 700 which is the top-left point of the exterior wall of the floor plan. Sine this first point is obviously as-yet unprocessed (since the algorithm has only just commenced) control passes from the decision step 804 to the further check 806 of whether the point is a corner of the building floor plan. If so (as will be the case for the top-left point of the building floor plan 100) the algorithm assigns a diagonal roof line in the direction away from the corner, ie diagonally from upper left to lower right. At step 810, an appropriate roof square is created at the corresponding grid point. The check at step 812 is to determine whether or not the algorithm has returned to the original roof square at the present roof level. If not, control passes to the process 814, which identifies and moves to the next adjoining square at the present level, such that the algorithm 800 will continue around the periphery of the building, ie normally passing control back to step 804.

If it is determined at step 812 that the original point at the current level has been reached, then control passes to process 816 which scans the building plan to identify the next roof square to be processed, at the next highest level in accordance with the (small) roof grid. Once the end of the grid is reached, ie there are no further unprocessed roof squares, the check at step 818 results in the algorithm 800 being terminated. Throughout the operation of the algorithm 800 a list of roof squares 820 is maintained, which records all of the roof elements that have been created at step 810.

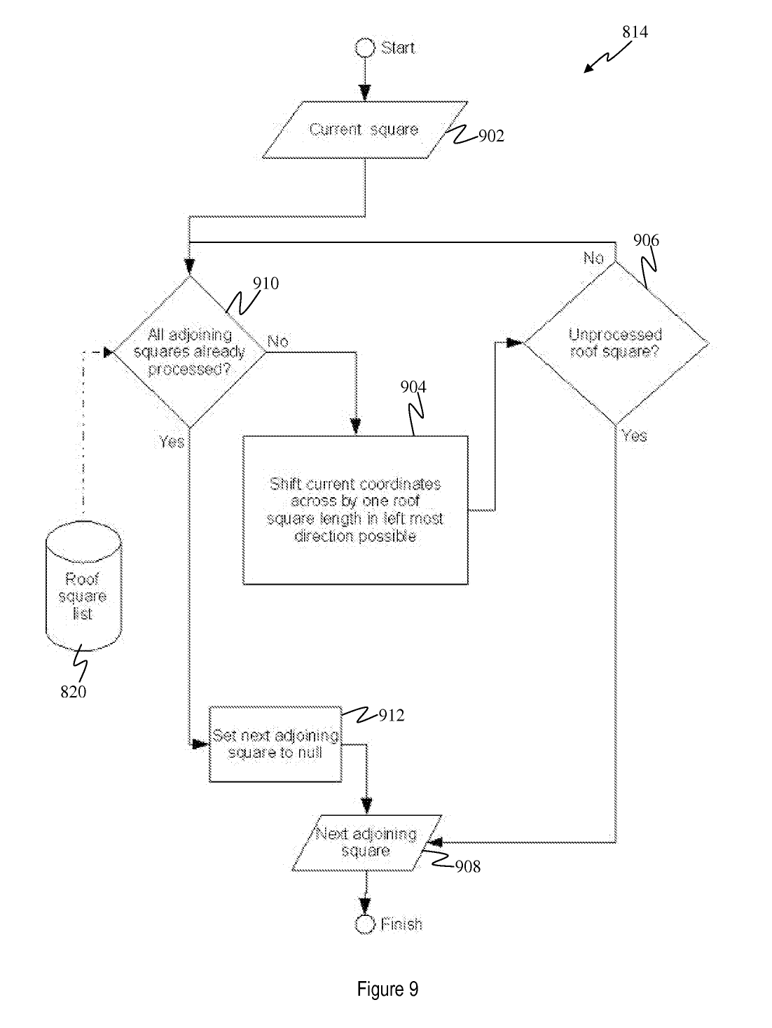

The process 814 which determines the next adjoining roof square is illustrated in greater detail by the flowchart in FIG. 9. The input 902 to the process 814 is the current square, and at step 904 the algorithm attempts to adjust the current coordinates in the left-most direction possible. At step 906, a check is performed to ascertain whether the resulting coordinates correspond with an unprocessed roof square. If so, then this roof square is output 908 as the next adjoining square. Alternatively, at step 910 the algorithm checks whether all of the available squares adjoining the current square 902 have been processed. If not, then steps 904, 906 and (if necessary) 910 are repeated until either an unprocessed adjoining roof square is identified (and output 908) or all of the available adjoining squares have been processed. This latter outcome should not occur in normal operation of the algorithm, however this exceptional event is signalled at step 912 by setting the next adjoining square to null.

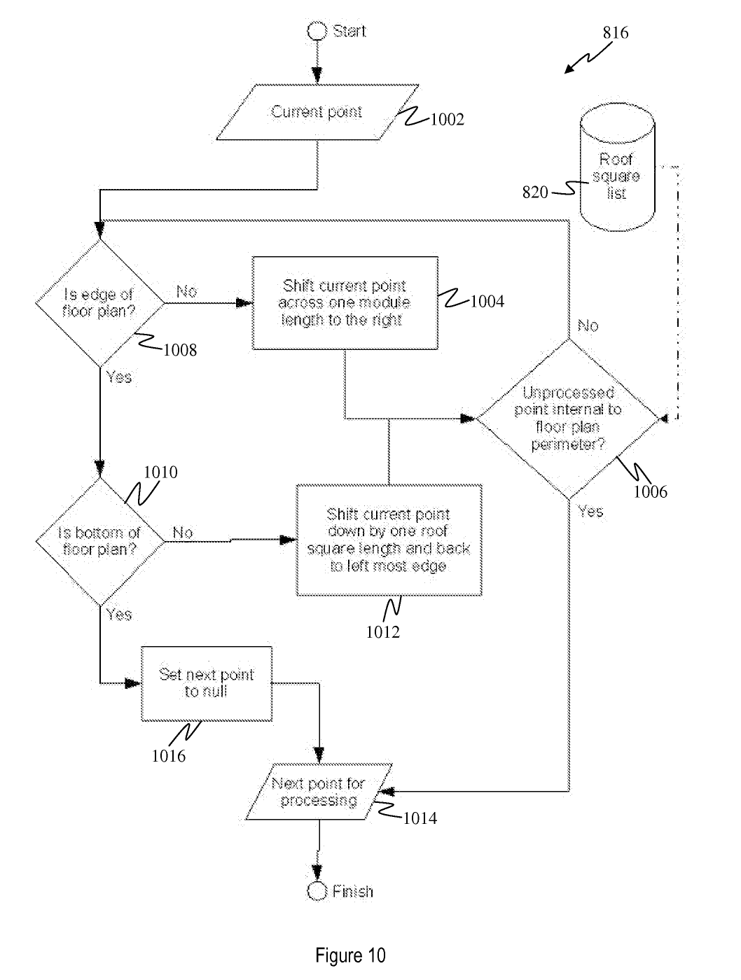

Turning now to FIG. 10, there is shown a flowchart for the process 816 for scanning to the next roof square. The input 1002 is the current point, and the basic strategy of the algorithm 816 is to commence searching to the right of this point at step 1004. A check is performed, at step 1006, to determine whether this new point is an unprocessed point internal to the floor plan perimeter. If not, a further check is performed, at step 1008, to detect whether the (right-hand) edge of the floor plan has been reached. If not, a further shift to the right is performed 1004, otherwise a check 1010 is made to ascertain whether the current point is at the bottom of the floor plan. If not, then at step 1012 the current point is shifted down by one roof square unit (ie half the initial grid size), and back to the left-most edge of the grid, at step 1012. It will therefore be appreciated that the scan to next square is performed from left to right and from top to bottom.

If at any stage in this process an unprocessed point internal to the floor plan perimeter is identified by the check 1006, then this point is output 1014 as the next point for processing. If no such point is found before the bottom right-hand corner of the floor plan has been identified, then the next point is set to null at step 1016, and this null value is output 1014.

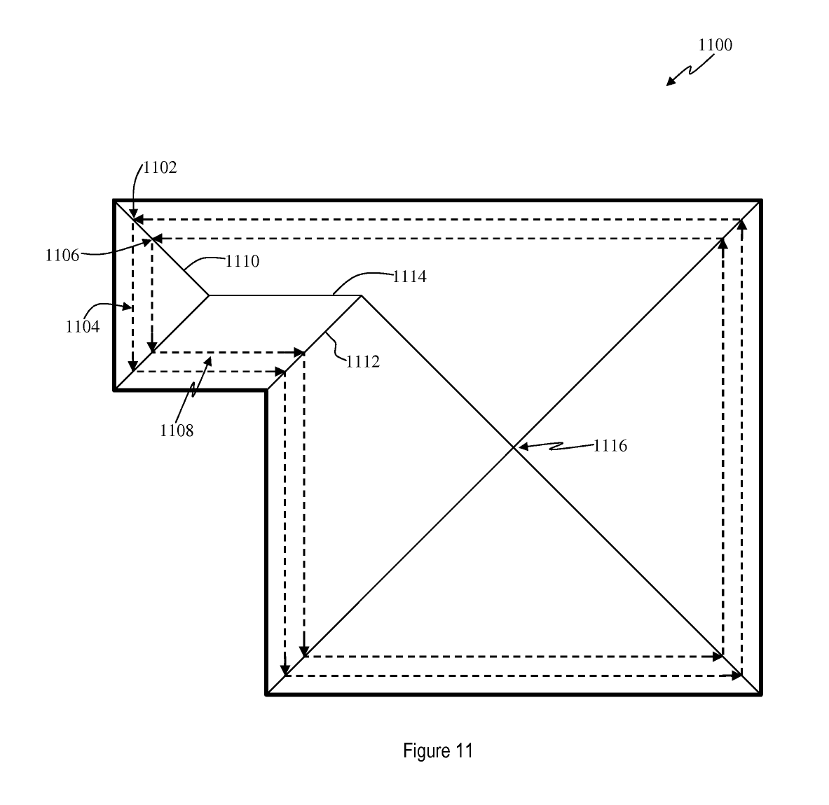

FIG. 11 is a diagram 1100 showing schematically the initial operation of the algorithm illustrated in FIGS. 8 to 10 upon the floor plan FIG. 1(b). The algorithm commences from the top-left point of the floor plan 1102. From here, it moves the “left-most” adjacent unprocessed roof square, which is located directly below the point 1102, and then proceeds, as indicated by the path 1104, around the perimeter of the roof in an anticlockwise direction.

Once the path has returned to the original point 1102, the scanning algorithm 816 commences searching to the right, and then downwards, finding the first unprocessed point internal to the floor plan perimeter one roof square unit below and to the right of the initial point 1102, ie the point 1106. Again, the algorithm 814 traces a corresponding path 1108 of constant roof height around the perimeter in an anticlockwise direction.

This process continues until all “contours” of constant height have been traced.

At each 90 degree turning point of each path, eg 1104, 1108, a diagonal roof line is assigned 808. In this manner, all of the ascending roof lines are identified. For example, the roof line 1110 is a roof hip rising from the top left-hand corner of the plan. Another type of roof line is the roof valley 1112. Also shown in the diagram 1100 is a horizontal roof ridge 1114, and a roof apex 1116. All of these features are fully determined by the roof line algorithm 800. Furthermore, upon completion of the algorithm every grid intersection within the area occupied by the roof has an associated height assigned to it. In general, all roof lines fall into one of the categories 1110, 1112, 1114 exemplified in the diagram 1100. In particular, a roof line extending upwardly from an external corner of the building defines a roof hip. A roof line extending upwardly from an internal corner of the building defines a roof valley. An unenclosed path of constant height defines a roof ridge.

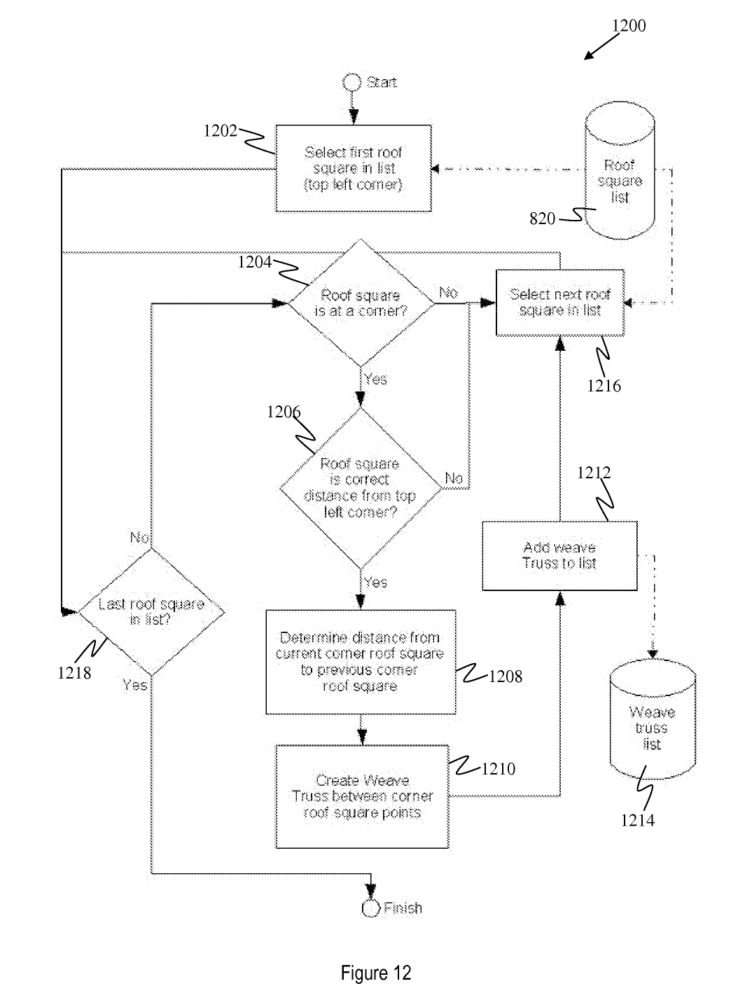

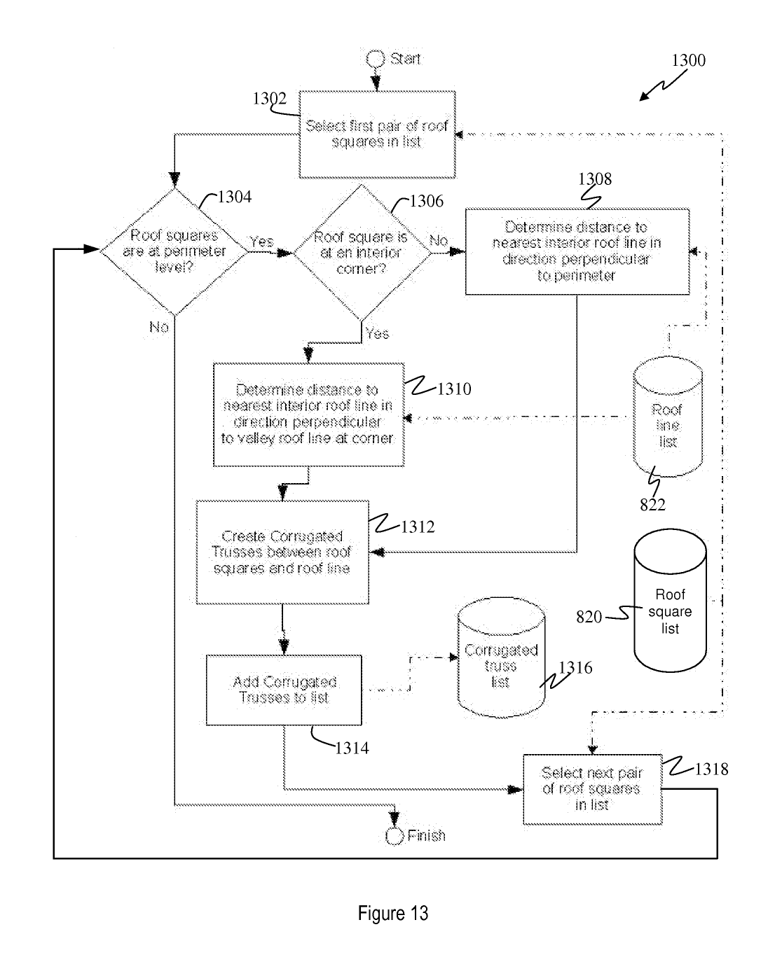

Referring back to FIG. 3(b), once a roof specification has been generated 312, the next step in the overall process is the generation of a roof support specification 314. The purpose of this stage is to determine where and how supporting members for the roof should be positioned. In accordance with the preferred embodiment, the supporting members include elongate trusses. Algorithms for determining the positions of these trusses are detailed in the flowcharts 1200, 1300 in FIGS. 12 and 13.

Preferably, the length of each truss is an integer multiple of a basic length, which is itself an integer multiple of the initial grid size. In the preferred embodiment, for example, the basic unit of length for the trusses is 1200 mm, ie twice the initial grid size. The truss members are located along either lateral or transverse lines parallel to the lines of the underlying grid, (ie “horizontally” or “vertically”) relatively to the building plan. The start and end points of each truss member must lie on an overlaid truss grid, which in the case of the preferred embodiment is a grid having a unit length (1200 mm) twice that of the underlying grid (600 mm). The objective of the algorithm 1200 is thus to identify all such pairs of truss end points, between which corresponding weave truss members will be placed.

The algorithm 1200 preferably utilises a single reference, typically the top-left corner of the building in plan view. Advantageously, ceiling modules include supporting trusses which will, in this scheme, be located directly below corresponding supporting trusses within the roof. At step 1202 the first roof square from the roof square list 820 is selected. According to the check 1204, if this roof square is located at a corner, the next step 1206 is to check whether this square is a relevant correct distance from the reference point (ie the top-left corner). Relevant correct distances are multiples of the basis unit truss length, ie 1200 mm and multiples thereof in the preferred embodiment. If this is the case, then at step 1208 the algorithm 1200 determines the distance between the current roof square, and the previous corner roof square, and at step 1210 creates a weave truss between these consecutive corner roof square points, which is added to a corresponding list 1214 at step 1212. The algorithm then proceeds, at step 1216, to select the next roof square in the list 820. The algorithm 1200 continues in this manner until it is determined, at step 1218, that the last roof square in the list has been reached.

The outcome of the algorithm 1200 is the weave truss list 1214, which comprises a set of supporting trusses aligned in the lateral and transverse directions, each located within the roof along a line of constant height between relevant consecutive corners of the roof. It will be understood that, in general, the algorithm 1200 traces around the contours, such as paths 1104, 1108 shown in FIG. 11, and places supporting weave trusses along some, but not necessarily all, of these paths. The reason that not all of the constant height paths have corresponding supporting trusses is that the paths are determined on a smaller grid (ie 300 mm in the preferred embodiment) whereas trusses are placed in accordance with a large grid (ie 1200 mm in the preferred embodiment). In alternative embodiments, however, in which the respective grids may be of the same unit size, supporting trusses may be created corresponding with every one of the constant height contour paths.

Whereas the algorithm 1200 places weave truss supports along lines of constant height within the roof structure, the purpose of the algorithm 1300 detailed in the flowchart of FIG. 13 is to place corrugated trusses along lines of varying height under the surface of the roof. At step 1302, the algorithm 1300 initially selects the first pair of roof squares in the list 820. The algorithm 1300 traverses the perimeter of the roof, and accordingly will be terminated when it is found, at step 1304, that the selected roof squares are not at the perimeter level. The algorithm initially proceeds to step 1306, which checks whether the selected roof squares are located at an interior corner. If not, then at step 1308 the algorithm accesses the roof line list 822, and determines the corresponding distance to the nearest interior roof line along a direction perpendicular to the perimeter at the present roof square location. Alternatively, if the roof square is located at an interior corner, the roof line list 822 is accessed at step 1310, in order to determine the distance to the nearest interior roof line along a direction perpendicular to the valley roof line (eg roof line 1112 in FIG. 11) corresponding with the interior corner. In either case, at step 1312, a supporting corrugated truss is created between the presently selected roof squares and the nearest relevant roof line identified in step 1308 or 1310. This corrugated truss is added to a corresponding list 1316 at step 1314. At step 1318 the next pair of roof squares is selected, and the algorithm continues, via step 1304, until all roof squares at the perimeter level have been processed.

The final stage in generation of the roof structure is to identify appropriate locations for supporting roof struts, and associated node points. In particular, in buildings designed in accordance with the preferred embodiment, the supporting truss members are maintained in position by struts extending from node points. Each such node point is supported by two struts, each of which is the same length, corresponding to the height of the roof at that particular node point. One strut will be oriented from the node point towards the nearest perimeter of the building, and the other will be oriented in the opposite direction. All struts traverse the same lateral distance. A general process for achieving this design objective involves firstly identifying a suitable initial node point on one of the truss members, and then selecting successive node points having a predetermined node spacing interval. Corresponding aligned node points are placed on every second parallel supporting weave truss member, and upon the intervening weave truss members node points are laterally offset by one half of the node spacing interval. The resulting set of node points thus resembles a recurring diamond pattern. This process is completed for the weave truss members aligned along the lateral direction, and is repeated to identify suitable node points for the weave truss members aligned in the transverse direction.

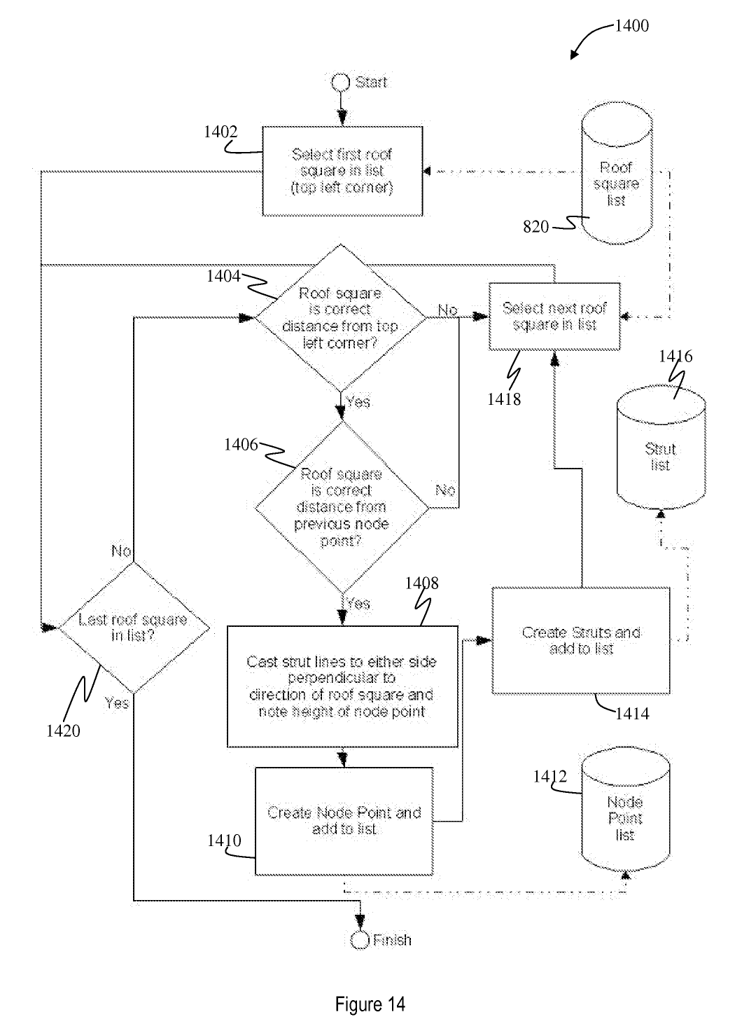

The algorithm 1400 for locating node points and struts is detailed in the flowchart shown in FIG. 14. Initially, at step 1402, the first roof square, ie in the top-left corner, is selected from the roof square list 820. At step 1404, a check is performed to determine whether the selected roof square is the correct distance from the reference point. A “correct distance” is determined in the same manner as at step 1206 of the algorithm 1200 for determining weave truss placement. This ensures that each node point is located on a weave truss supporting member. At step 1406, a further check is performed to determine whether the roof square is a relevant distance from a previously placed node point. This distance corresponds with the predetermined node point spacing, and ensures that node points are placed at the desired distance apart. Only if both of the tests 1404, 1406 are passed, does control advance to step 1408, at which the corresponding pair of strut lines are cast, and the height of the node point noted. At step 1410 the node point is created and added to a node point list 1412, and then at step 1414 the struts are created and added to a strut list 1416. At step 1418, the next roof square in the list 820 is selected, and if this is not determined to be the last roof square at step 1420, then the node and strut determination algorithm continues until all roof squares have been processed.

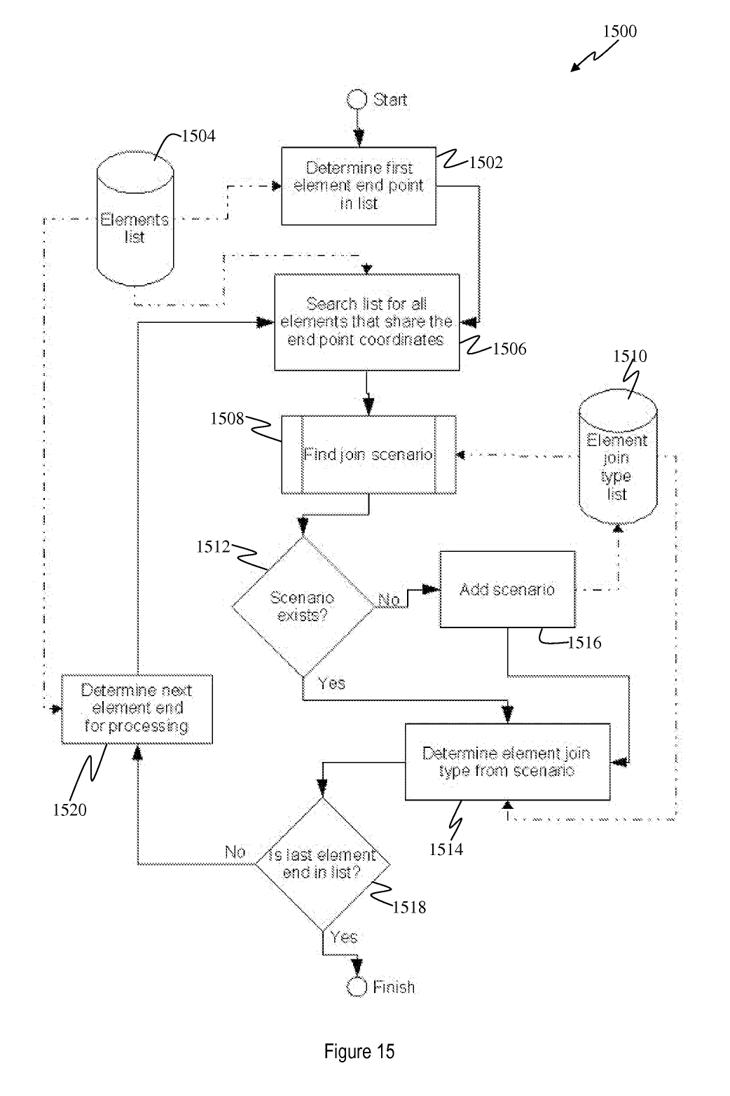

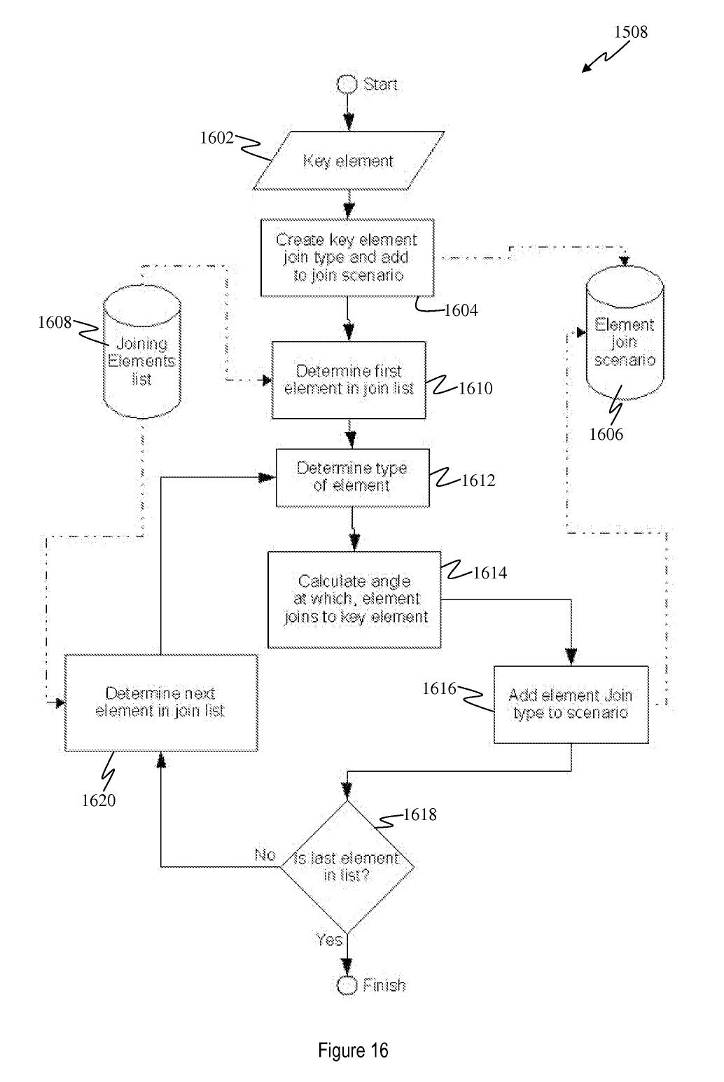

In order to produce a final building specification 316, it is necessary to consider how each of the individual elements making up the structure is connected to other elements. In particular, elements are connected by joins, and these joins are, at least in part, characterised by the angles at which the various connected elements meet at the join. In a preferred embodiment, all possible join types and angles are stored in a database, each being termed a join “scenario”, and with each scenario being allocated a unique identifying number. For each join scenario, the database also includes information such as details of the type of joining element required, its cost and its weight. An algorithm for determining all of the join types within a building design is detailed in the flowcharts 1500, 1508, shown in FIGS. 15 and 16. At the commencement of the algorithm 1500, the first step 1502 is to select a first element from a list 1504 of all elements within the building design, and identify a first corresponding element end point. At step 1506, the elements list 1504 is searched in order to identify all further elements sharing the same end point coordinates. Clearly, elements sharing common end point coordinates are joined at that point.

At step 1508, the algorithm attempts to find a corresponding join scenario within the database 1510. Assuming there is an appropriate existing scenario, as determined at step 1512, corresponding join type information is extracted from the database 1510 at step 1514. If there is no existing scenario, as may happen if an unusual combination of elements requires joining, then at step 1516 a corresponding new scenario is added to the database 1510.

A check is performed at step 1518 to determine whether the last element end point has been processed. If not, a new element end point is selected from the elements list 1504 at step 1520. Otherwise, the algorithm terminates.

FIG. 16 shows in greater detail the process 1508 for finding a join scenario. As previously noted, a join scenario comprises at least two or more elements to be joined, along with the angles therebetween. The relevant angles may be determined by consideration of the joint geometry, and in particular via trigonometric calculation methods. Joins may exist between the structural elements, the specification which has been described above, or may be joins to non-structural parts of the building, such as a roof element which ends at a gutter, or a wall element that ends at a doorway. In cases of the latter type, the join angle may be set to a null value.

In order to find a corresponding join scenario, a key element 1602 is selected from the elements making up the join. That is, in order to facilitate searching within the database each join scenario is linked to a particular building element, which then serves as a key entry in the database. The join angles, and joining parts, may then be determined with reference to the key entry. As such, at step 1604 a key element join type is created and added to a current join scenario 1606. At step 1610, a first element is identified in the join list 1608, and the type of this element is determined at step 1612. The angle at which the selected element joins to the key element is calculated at step 1614. The element type and join angle is added to the scenario 1606 at step 1616. While there remain further elements within the joining elements list 1608, as determined at step 1618, the algorithm proceeds to determine the next element in the join list, at step 1620, and then repeats steps 1612, 1614 and 1616 until all elements have been processed. The final result is an element join scenario 1606 which should correspond with one of the scenarios in the database 1510.

The length of each building element can further be determined using relevant geometrical and/or trigonometric formulae. The formation of elements such as trusses and struts, which may have a variety of different lengths, may involve the joining of multiple constituent members of smaller size. Accordingly, a separate database table may be provided which contains information regarding available lengths for basic elements, and instructions for joining two or more members, where necessary, to achieve required lengths.

Once the building design is completed, and/or at appropriate points during the building design procedure, the design may be tested in order to verify compliance with predetermined rules or criteria, such as structural strength criteria. In particular, with reference to FIG. 2(b), structural information regarding the design stored within the database 222 may be accessed by the engineering testing engine 224, and passed to the structural engineering software component 228 via the automation interface 226. The structural engineering software 228 is configured to test the proposed structure against relevant engineering codes. Alternatively, or additionally, predetermined rules obtained through use of structural engineering software 228 may be stored within the database 222, and utilised by the engineering testing engine 224 for verification that the design satisfies the relevant structural criteria.

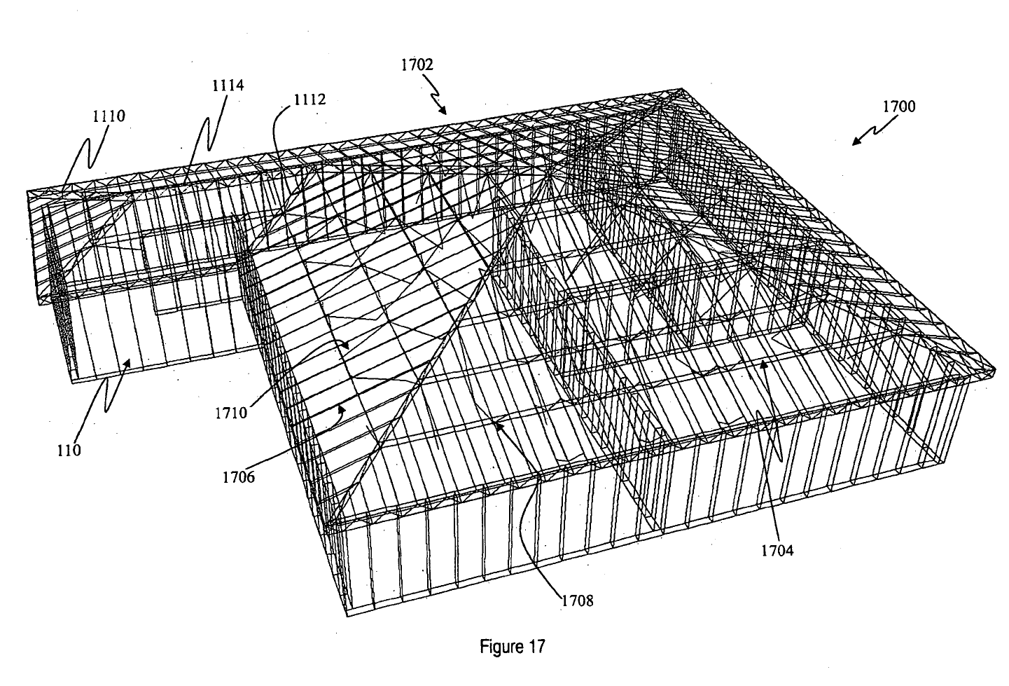

FIG. 17 illustrates a three-dimensional graphical model 1700 of a building design using a computer-software-implemented embodiment of the present invention, and corresponding with the floor plan 100 shown in FIG. 1(b). Many of the structural design features resulting from execution of the methods and algorithms described previously with reference to FIGS. 4 to 16 may be observed in the “wireframe” model 1700. Exterior walls, eg 110, are clearly visible. Furthermore, the completed roof design 1702, which was generated in a fully automated manner, is also visible, including elements of the internal supporting structure. The wireframe model 1700 clearly depicts the roof lines, including, for example, the roof hip 1110, the roof valley 1112, and the roof ridge 1114.

Also clearly visible within the wireframe model 1700 are the weave trusses, eg 1704, the corrugated trusses, eg 1706, the node points, eg 1708, and the struts, eg 1710, comprising the automatically generated roof support structure.

Once the final design has been completed and verified, relevant output files may be generated. In particular, a parts list may be generated which includes all components and modular elements required for construction of the building. Advantageously, the parts list may be ordered in any desired manner. In particular, it may be useful to generate a parts list that is arranged according to the order in which parts will be required for construction of the building. In this way, parts may be packed for shipping in the reverse order of requirement for construction, such that the first required parts will be unpacked prior to later required parts. This approach facilitates efficient packing, transport, unpacking and construction of the final building.

Additional output data and files that may be generated include a bill of costs, setting out prices of all of the components and modular elements required for construction of the building and/or all relevant totals. A further output file may be provided including relevant instructions for construction of the building. These exemplary output files are not intended to be limiting, and it will be appreciated that other information, such as structural data, as well as other design data and statistics, may be generated, stored and/or output as part of the overall computer-aided design procedure.

It will be understood that while an exemplary embodiment of the invention has been described herein, this should not be considered to limit the scope of the invention, as defined by the claims appended hereto.

1. An automated method of generating a specification for construction of a building from modular elements selected from a predetermined set of modular element types, the method including the steps of:
receiving computer-readable input data representative of a user-generated floor plan which comprises a plurality of said modular elements arranged in accordance with a regular grid;
processing the input data to produce computer-readable building specification data which includes a specification for construction of a building from said modular elements, in accordance with the floor plan; and
generating at least one output file including information for use in construction of a building in accordance with the building specification data.

2. The method of claim 1 wherein the step of processing the input data to produce computer-readable building specification data includes verifying that the input data represents a floor plan of an enclosed building structure and/or identifying enclosed areas of the floor plan.

3. The method of claim 2 wherein identifying enclosed areas includes one or more steps of:
scanning the regular grid to identify a location of an initial modular wall element, and
commencing at said initial modular wall element, traversing a perimeter of adjacent modular wall elements in order to identify an enclosed area.

4. The method of claim 3 wherein traversing a perimeter includes following one or more possible paths in the event that a junction of multiple modular wall elements is encountered.

5. The method of claim 1 wherein the step of processing the input data to produce computer-readable building specification data further includes generating a specification for construction of a roof of the building based upon the floor plan represented by the input data.

6. The method of claim 5 wherein generation of the roof construction specification includes determining heights and locations of roof lines, including roof ridges, roof hips and/or roof valleys.

7. The method of claim 5 wherein generation of the roof construction specification includes one or more steps of:
scanning the regular grid to identify a location of an initial roof element, and
commencing at said initial roof element, traversing a sequence of adjacent roof elements located at the same height as the initial roof element.

8. The method of claim 7 which determines roof lines including:
a plurality of roof hips defined by diagonal lines of increasing height extending from an external corner of the building;
zero or more roof ridges defined by unenclosed paths of constant height; and
zero or more roof valleys defined by diagonal lines of increasing height extending from an internal corner of the building.

9. The method of claim 5 wherein generating a specification for construction of a roof further includes generating a specification for construction of a roof support structure.

10. The method of claim 9 wherein generating the roof support structure specification includes determining placement of a plurality of first supporting members located along lateral and transverse lines running parallel to lines of the regular grid, and arranged in a horizontal configuration.

11. The method of claim 9 wherein generating the roof support structure specification includes determining placement of a plurality of second supporting members located along lines of increasing height between a perimeter of the roof and a corresponding nearest roof line.

12. The method of claim 11 which further includes determining placement of a plurality of the second supporting members located along lines of increasing height between a roof valley and a corresponding nearest roof ridge or roof hip.

13. The method of claim 9 wherein generating the roof support structure specification includes determining placement of a plurality of third supporting members located within the roof, and extending from node points positioned on first supporting members located along lateral and transverse lines running parallel to lines of the regular grid.

14. The method of claim 1 wherein the step of processing the input data further includes determining the location, type and characteristics of all joins required for construction of the building.

15. The method of claim 1 wherein the output files generated by the automated method include one or more of:
a parts list including all components and modular elements required for construction of the building;
a bill of costs, including prices of all components and modular elements required for construction of the building; and
instructions for construction of the building.

16. The method of claim 1 which includes a further step of verifying that the building construction meets relevant design criteria, such as structural strength criteria.

17. A computer-implemented system for generating a specification for construction of a building from modular elements selected from a predetermined set of modular element types, the system including:
one or more processors;
at least one input interface operatively associated with the processor(s);
at least one output interface operatively associated with the processor(s); and
at least one storage medium containing program instructions for execution by the processor(s), said program instructions causing the processor(s) to execute the steps of:
receiving, via said at least one input interface, computer-readable input data representative of a user-generated floor plan which comprises a plurality of said modular elements arranged in accordance with a regular grid;
processing the input data to produce computer-readable building specification data which includes a specification for construction of a building from said modular elements in accordance with the floor plan; and
generating at said at least one output interface, at least one output file including information for use in construction of a building in accordance with the building specification data.

18. The system of claim 17 wherein the input and output interfaces include at least one network interface connecting the one or more processors to a data network, wherein input data and output files are transmitted between the system and an end-user via the data network.

19. The system of claim 18 wherein the data network is the Internet, and the system provides a web-based building design service.

20. A computer-implemented system or apparatus for generating a specification for construction of a building from modular elements selected from a predetermined set of modular element types, the system or apparatus including:
means for receiving computer-readable input data representative of a user-generated floor plan which comprises a plurality of said modular elements arranged in accordance with a regular grid;
means for processing the input data to produce computer-readable building specification data which includes a specification for construction of a building from said modular elements in accordance with the floor plan; and
means for generating at least one output file including information for use in construction of a building in accordance with the building specification data.

21. A computer-readable medium having computer-executable instructions embodied thereon, which when executed cause a computer to execute a method according to claim 1.
